(19) United States
(12) Patent Application Publication
(10) Pub. No.: US 2006/0179618 A1
(43) Pub. Date: Aug. 17, 2006

(54) Rope hitch

(76) Inventor: Wayne Michael Radford, Molendinar (AU)

Correspondence Address: NATH & ASSOCIATES, 112 South West Street, Alexandria, VA, 22314, US

(21) Appl. No.: 10/541,342

(22) PCT Filed: Jun. 17, 2002
(86) PCT No.: PCT/AU02/00789

§ 371 Date: Jul. 5, 2005

(51) Int. Cl. F16G 11/00

(52) U.S. Cl. 24/129 R

(57) ABSTRACT

A unitary hitch (1) comprises an elongated shank (2) having front (3), rear (4) and side (5) faces, a pair of hooks (6) at one end of the shank (2) and a closed eyelet (7) at the other end of the shank (2), wherein the hooks (6) extend from opposite side faces (5) of the shank (2) and the hooks (6) are coplanar with the eyelet (7). A method of using the rope hitch (1) is also described.

### TECHNICAL FIELD

The present invention relates to rope tensioners and hitches of the type which can be used to tie down, support or anchor loads.

### BACKGROUND ART

There are many currently available rope tensioning devices and hitches for tensioning ropes, load support and for hauling a range from elaborate lever type devices to more simply constructed tensioners.

Such devices are commonly used in transportation's and yachting fields and the cost of these products varies.

Whilst most trade and transport industry workers are able to competently secure loads using devices and secure knotting techniques the general public's ability to tie an adequate knot for the purpose of securing and tensioning ropes and loads is often somewhat limited.

This can lead to potentially dangerous on road situations as in busy traffic if a load or part of load is lost there is a high risk of an accident occurring.

Lives have been lost when people have taken action to avoid lost loads resulting in deaths.

U.S. Pat. No. 5,220,709 describes a device to assist manual tightening of a rope passed over a load on a vehicle.

The device is first attached too the rope by passing the rope from the upper side of the device through guide to the lower side, then passing the rope up into the lower notch and over the upper side of the device and into the upper notch so that pulling the rope downwardly will secure the device to the rope.

Tensioning may then be achieved by forming a loop in a portion of the free end of the rope, passing the loop around a fixed anchorage site on the vehicle and locating a portion of the loop over the pair of arms.

The free end of rope is then passed behind and over the portion of rope extending between the pair of arms and pulled downwardly, thereby urging the rope that extends between the pair of tensioning arms downwardly and causing tension to be applied to the rope.

The taut rope is then secured by tying the free end thereof to a fixed anchorage site.

The device and in particular the method of tying described is somewhat complicated and as such unlikely to appeal to the inexperienced who would prefer a more simple methodologies.

It is an object of the present invention to provide a rope hitch which is simple to use, which can be used for tensioning a rope, supporting or hauling a load and which relieves the pressures on tie down points.

Further objects and advantages of the present invention will become apparent from the ensuing description which is given by way of example only.

### DISCLOSURE OF INVENTION

According to the broadest aspect of the present invention there is provided a rope hitch comprising an elongate shank, a hook at one end of the shank and a closed eyelet at the other end of the shank.

The hook can be orientated to accept a pass of a rope in a first plane and the eyelet is adapted to accept a pass of a rope in a second plane at ninety degrees to the first plane.

According to the present invention, there is provided, a unitary rope hitch comprising an elongate shank, having front, rear and side faces, a pair of hooks at one end of the shank and a closed eyelet at the other end of the shank, characterised in that the hooks extend from opposite side faces of the shank and in that the hooks are co-planar with the eyelet.

According to a further aspect of the present invention there is provided a method of tensioning and securing a rope using a rope hitch as aforesaid comprising the steps of making a first pass of a free end of a rope through the eyelet of the hitch, wrapping the rope around the shank of the hitch proximate to the eyelet making a second pass of the rope through the eyelet so that the second pass of the rope overlies the first pass and tensioning the rope and securing the rope with respect to a remote tie down point.

The method may include the further steps of returning the free end of the rope from the remote tie down point, making a first pass of the rope over one of the opposed hooks, returning the rope to the remote tie down point, making a second pass of the rope over a second of the opposed hooks, returning the rope to the remote tie down point and securing the rope at the tie down point.

### BRIEF DESCRIPTION OF THE DRAWINGS

Aspects of the present invention will now be described with reference to the accompanying drawings in which;

FIG. 1 is a side view of a rope hitch according to one embodiment of the present invention, and

FIGS. 2 and 2a are side and end views of a rope hitch according to a further aspect of the present invention, and

FIG. 3 is a side view of a rope hitch according to a still further aspect of the present invention, and

FIG. 4 showing the use of the rope hitch of FIG. 1 used to tie down a load with respect to a remote fixture point, and

FIG. 5 is a side view of a vehicle carrying a load indicating the preferred positioning of the rope hitches in relation to a load and tie claim point.

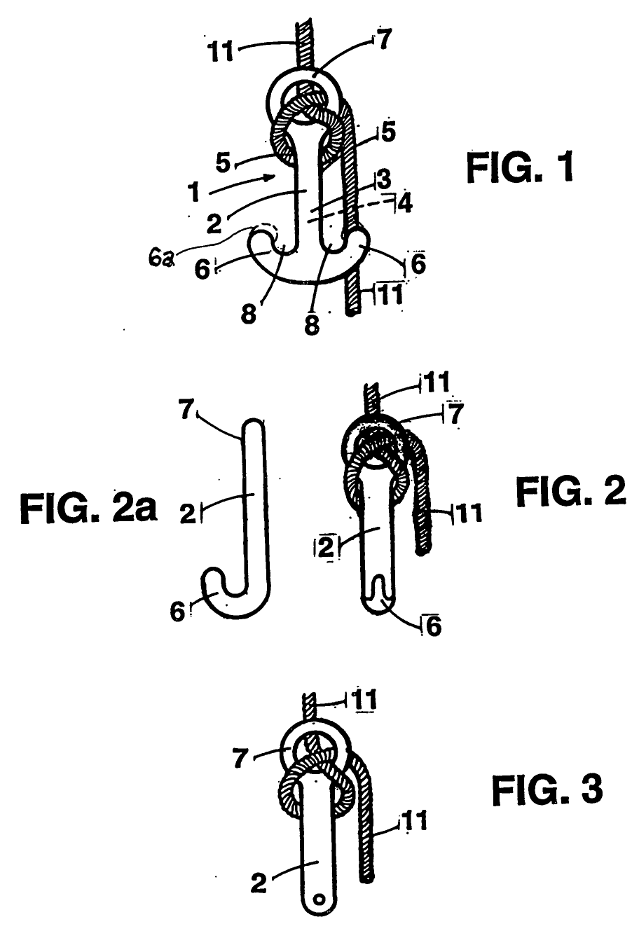

With respect to FIG. 1 of the drawings according to one aspect of the present invention there is provided a rope hitch generally indicated by arrow 1 comprising an elongate shank 2 having front and rear faces 3,4 side faces 5 and a pair of hooks 6 at one end of the shank 2 which extend from the side faces 5.

A closed eyelet 7 is provided at the other end of the shank 2.

The hooks 6 are co-planar with the eyelet.

The longitudinal axis of channels 8 of the hooks 6 are parallel with the axis of the eyelet 7.

FIGS. 2 and 3 of the drawings illustrate other possible forms of hitch according to the present invention both of which have an elongate shank 2 and a closed eyelet 7.

In the FIG. 2 embodiment the hitch has a single hook 6 and a channel 9 created by the hook has a longitudinal axis which is at ninety degrees to the axis of the eyelet 7.

In the FIG. 3 embodiment the end of the shank 2 opposite the eyelet 7 is provided a cord attachment 10.

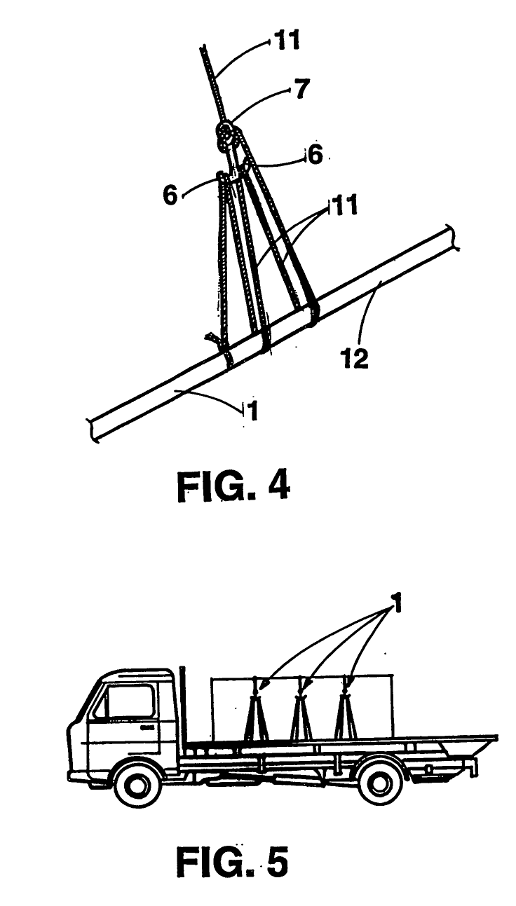

FIG. 4 of the drawings in configuration with the previous figures illustrates the manner in which the hook 1 is used to tension and secure a rope.

To tension and secure a rope 11 a first pass of a free end of rope is made through the eyelet 7 of the hitch.

The rope is then wrapped around the shank of the hitch proximate to the eyelet 7 and a second pass of the rope through the eyelet is made so that the second pass overlies the first pass.

The free end of the rope is then attached to a remote tie down point 12, and returned making a first pass over one of the opposed hooks, returning the rope to the remote tie down point, making a second pass of the rope over a second of the opposed hooks 6 and returning the rope to the remote tie down point where the rope is tied.

Similar techniques are used to secure the rope to the eyelets of the FIGS. 2 and 3 embodiments with the overlapping of the rope at the eyelet providing a braking affect.

In the case of the FIG. 2 embodiment a single pass is made over the sole hook 6 thereof.

FIG. 5 of the drawings illustrates the preferred positions of the hitches 1 relative to a load and a tie down point 12.

To increase the security of location of a rope in any tie down situation the ends 6a of the hooks 6 may be enlarged as indicated in broken outline in FIG. 1 to narrow the passage into the channels 8.

Aspects of the present invention have been described by way of example only and it will be appreciated that modifications and additions thereto may be made without departing from the scope thereof, as defined in the appended claims.

1. A unitary rope hitch comprising an elongate shank, having front, rear and side faces, a pair of hooks at one end of the shank and a closed eyelet at the other end of the shank, characterised in that the hooks extend from opposite side faces of the shank and in that the hooks are co-planar with the eyelet.

2. A method of tensioning and securing a rope using a rope hitch as claimed in claim 1 comprising the steps of making a first pass of a free end of a rope through the eyelet of the hitch, wrapping the rope around the shank of the hitch in a proximate position to the eyelet making a second pass of the rope through the eyelet so that the second pass of the rope overlies the first pass and tensioning the rope and securing the rope with respect to a remote tie down point.

3. A method of tensioning and securing a rope as claimed in claim 2 including the steps of returning the free end of the rope from the remote tie down point, making a first pass of the rope over one of the opposed hooks, returning the rope to the remote tie down point, making a second pass of the rope over a second of the opposed hooks, returning the rope to the remote tie down point and securing the rope at the tie down point.
